(19) United States
(12) Patent Application Publication
(10) Pub. No.: US 2026/0095108 A1
(43) Pub. Date: Apr. 2, 2026

(54) SYSTEM AND METHOD FOR ASSEMBLING A POWER MODULE DEVICE WITH A MOLDED HOLDER

(71) Applicant: DANA TM4 ITALIA S.R.L., Vicenza (IT)

(72) Inventors: Walter FAEDO, Vestenanova (IT); Mirko SGAGGIO, Vestenanova (IT); Pierpaolo ZULPO, Arzignano (IT)

(21) Appl. No.: 18/902,356

(22) Filed: Sep. 30, 2024

(51) Int. Cl. H02M 7/00

(52) U.S. Cl. CPC H02M 7/003

(57) ABSTRACT

A holder for a power module device that positions, centers, and insulators various components of the power module device is described herein. The holder comprises a plurality of power terminal slots configured for positioning and centering power terminals, two busbar slots configured for positioning and centering two busbars, a plurality of power module slots configured for positioning and centering power modules, a plurality of locking slots, a plurality of insulators disposed in the plurality of power terminal slots and the plurality of power module slots; a plurality of locking clips integrated into sides of the plurality of power terminal slots, a periphery of the holder at each end of the holder, and a surface of the holder, and a removable locking member located on an edge of the holder prior to being removed.

### TECHNICAL FIELD

The present disclosure relates to a holder for power module devices, including inverters, converters, electric drives and the like.

### BACKGROUND AND SUMMARY

Existing power module devices rely on separate elements to perform different functions, including assembly, centering, and insulation of the power module device. More specifically, existing inverter power stages rely on components, such as power modules, power boards, and screws, to be positioned and assembled in a step-by-step manner. Once assembled, the components are fixed with the screws to ensure proper placement of the components, which ensures that the components are able to withstand mechanical vibrations and shocks. Further, plastic insulators provide electrical insulation between each screw and a heatsink/baseplate. However, relying on separate elements to perform different functions may complicate the manufacturing process, which in turn, may result in more assembly errors and greater takt times. In particular, assembly of the inverter power stage may be prone to incorrect placement of the components, other assembly errors, and breakage of the components.

U.S. Pat. No. 10,772,242 B2 discloses a power module integrated in an inverter. The power module includes a locator that comprises a plurality of slots wherein a plurality of transistors is disposed within the plurality of slots. The plurality of transistors is coupled with the plurality of slots by at least one clip. The power module may further include a laminated busbar that is coupled to a gate drive printed circuit board and disposed over a first surface of the locator. In some embodiments, the power module may be coupled to a subassembly that includes a positive busbars, negative busbars, and a holder that aligns the positive busbars and negative busbars.

The disclosure discussed above relies on a locator to position some components of the power module as well as a holder to position some components of the subassembly and couple the power module and the subassembly. Although the locator and holder may position some components of the inverter as demanded to reduce some potential assembly errors, the locator and the holder do not reduce assembly errors associated with insulation components and other components of the inverter, including the power terminals, the power board, and the like.

The inventors herein have recognized the above issues and provide approaches to at least partially address them, including a holder for a power module device comprising a plurality of power terminal slots configured for positioning and centering power terminals, two busbar slots configured for positioning and centering two busbars, a plurality of power module slots configured for positioning and centering power modules, a plurality of locking slots for coupling the plurality of power terminals, two busbars, and a plurality of power boards to the holder, a plurality of insulators disposed in the plurality of power terminal slots and the plurality of power module slots wherein each insulator positions a fastener that couples the plurality of power terminals and the two busbars to a heatsink of the power module device, a plurality of locking clips integrated into sides of the plurality of power terminal slots, a periphery of the holder at each end of the holder, and a surface of the holder, and a removable locking member located on an edge of the holder prior to being removed. In this way, the holder may perform various functions, including positioning, centering, and insulation of various components of a power module device. Since the holder performs several functions, a number of components of the power module device may be reduced, and accordingly, a number of assembly steps may be reduced as well, which may reduce assembly errors and increase quality of the power module device.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

The above, as well as other advantages of the presently proposed holder and inverter assembly and assembly method will become apparent to those skilled in the art from the following detailed description of exemplary embodiments of the assembly and method when considered in the light of the accompanying drawings. The drawings described herein illustrate embodiments of the presently disclosed subject matter, and are illustrative of selected principles and teachings of the present disclosure. However, the drawings do not illustrate all possible implementations of the presently disclosed subject matter, and are not intended to limit the scope of the present disclosure in any way.

### BRIEF DESCRIPTION OF THE FIGURES

FIG. 1 schematically shows a vehicle, in accordance with one or more embodiments of the present disclosure.

FIG. 2 schematically shows an exploded view of an inverter assembly with a holder integrated therein.

FIG. 3 schematically shows a top view of the holder integrated within the inverter assembly of FIG. 1.

FIG. 4 schematically shows a shows a cross section view of the inverter assembly of FIG. 1.

FIG. 5 schematically shows an example method for assembling the inverter assembly.

FIGS. 6A-6E schematically show different steps of assembling the inverter assembly of FIG. 1.

FIG. 7 schematically shows a first perspective view of an assembled inverter assembly.

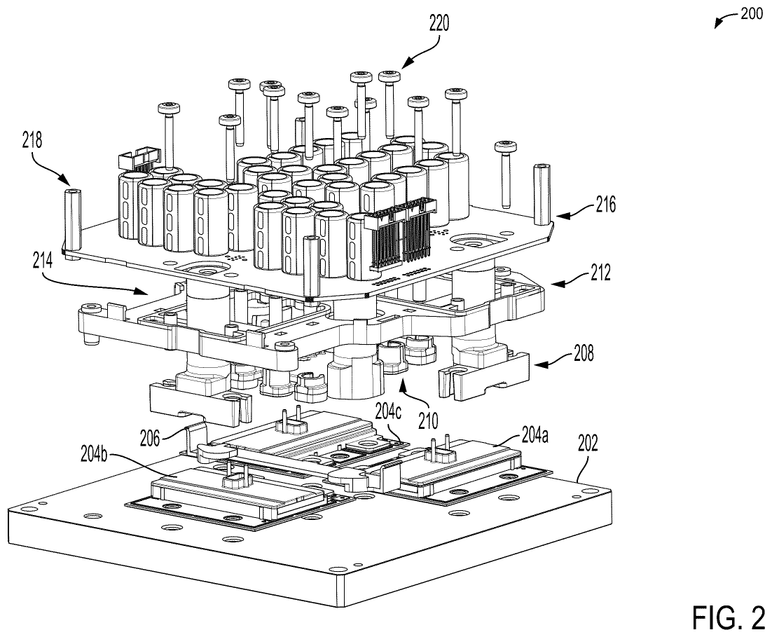

Similar reference numerals may have been used in different figures to denote similar components. FIGS. 2-4 and 6A-7 are shown with components in proportional size with one another, according to some embodiments.

### DETAILED DESCRIPTION

A power module device, such as an inverter assembly, that integrates a molded holder configured with a removable locking member that positions, centers, and insulates various components of the power module device and a method for assembling the power module device is described herein. The holder is configured to position a plurality of power terminals, two busbars (e.g., a positive busbar and a negative busbar, and a plurality of power modules of the power module device. The holder is also configured with a plurality of insulators that electrically insulates a plurality of fasteners from other components of the power module device. The holder also integrates a plurality of locking slots and a plurality of locking clips to couple the plurality of power terminals, the two busbars, and the plurality of power modules to the holder.

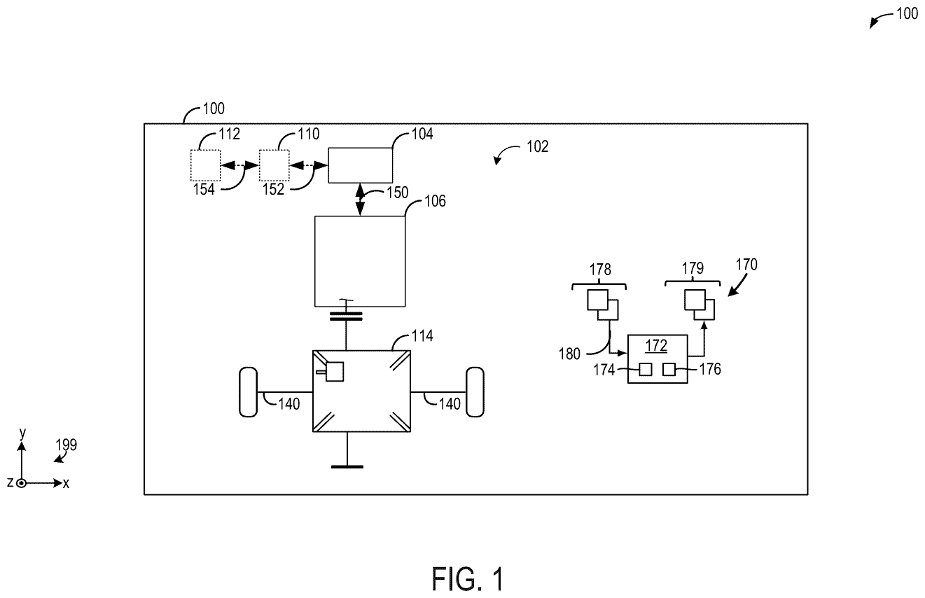

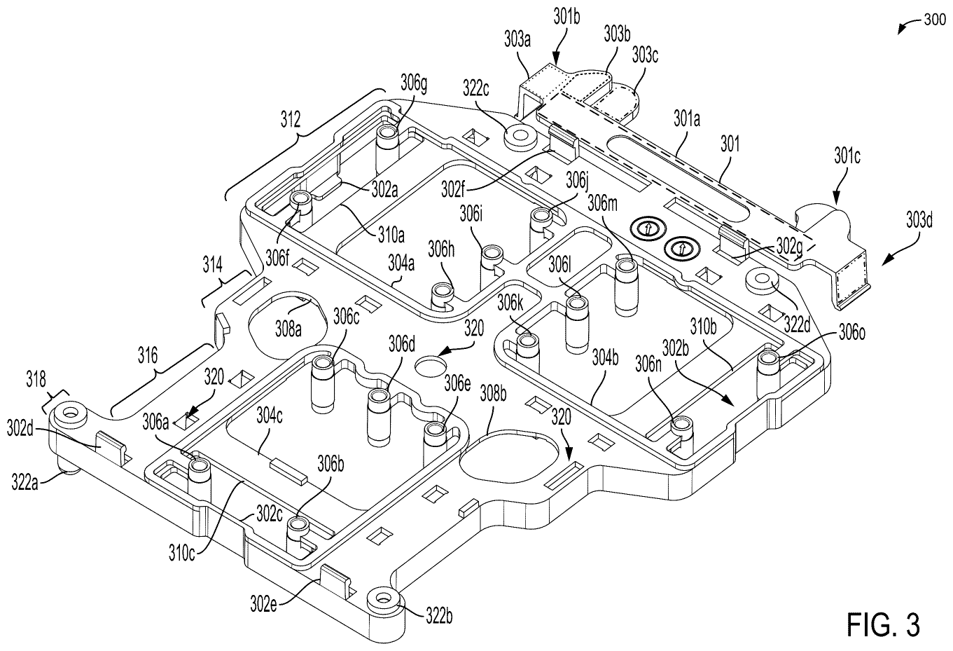

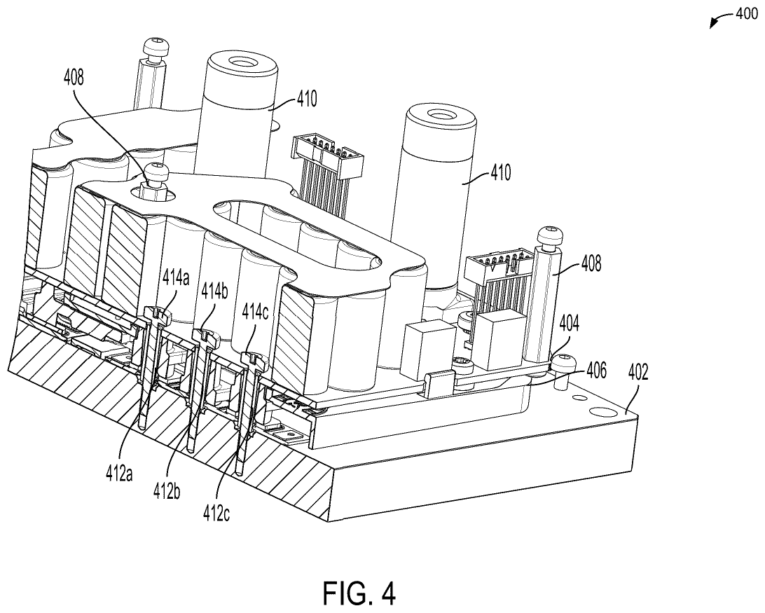

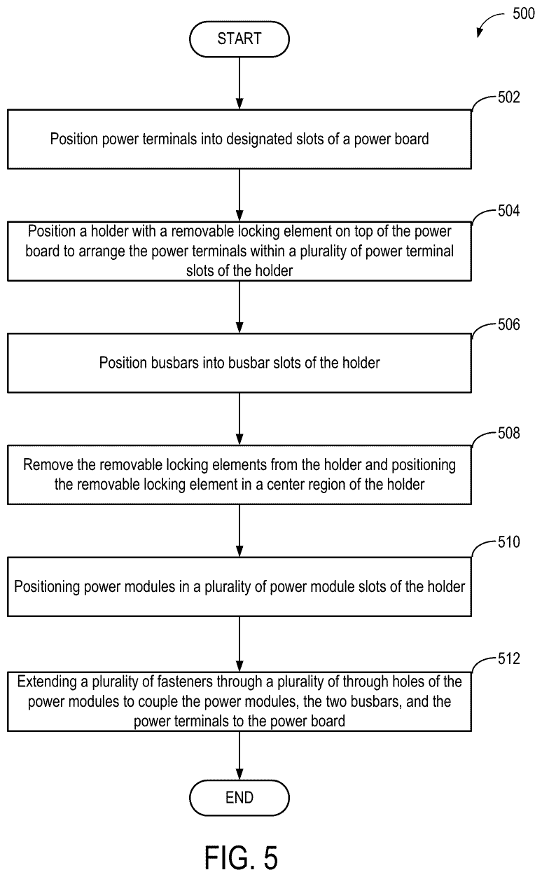

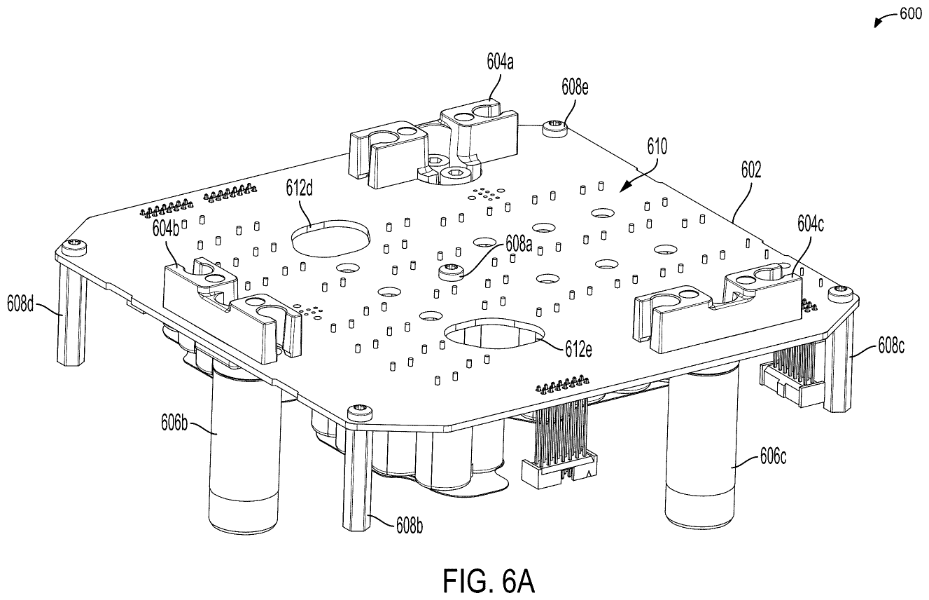

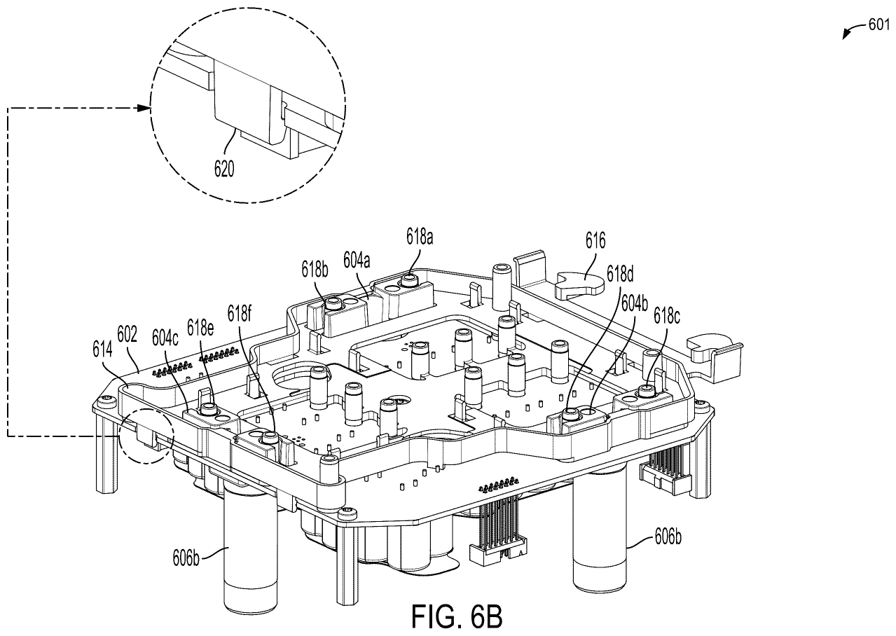

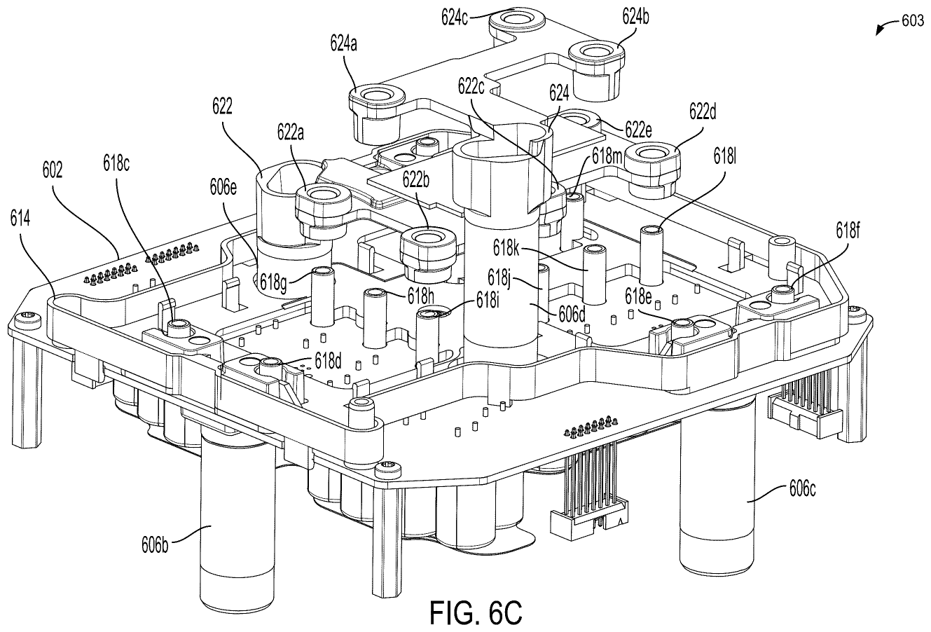

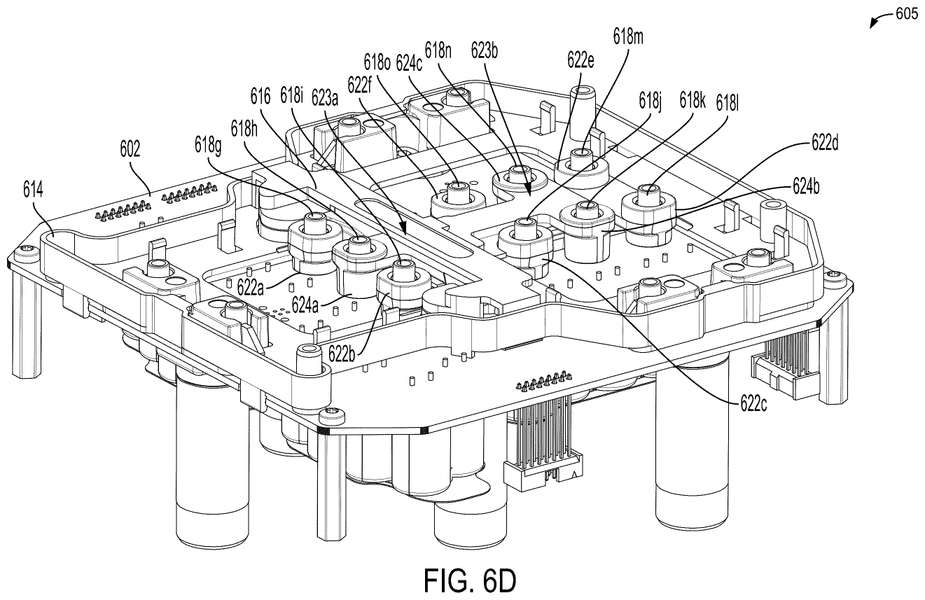

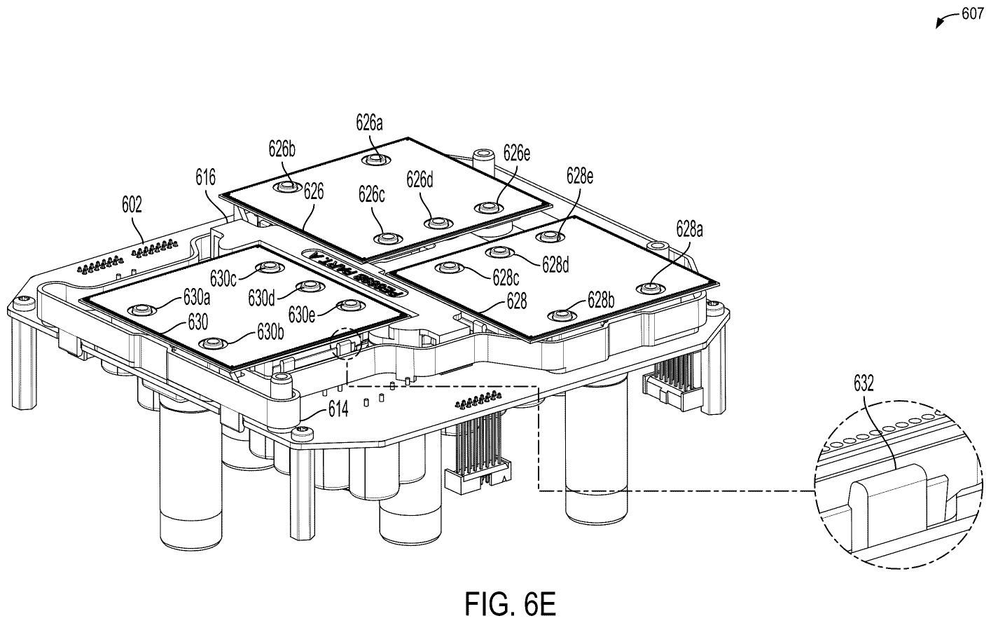

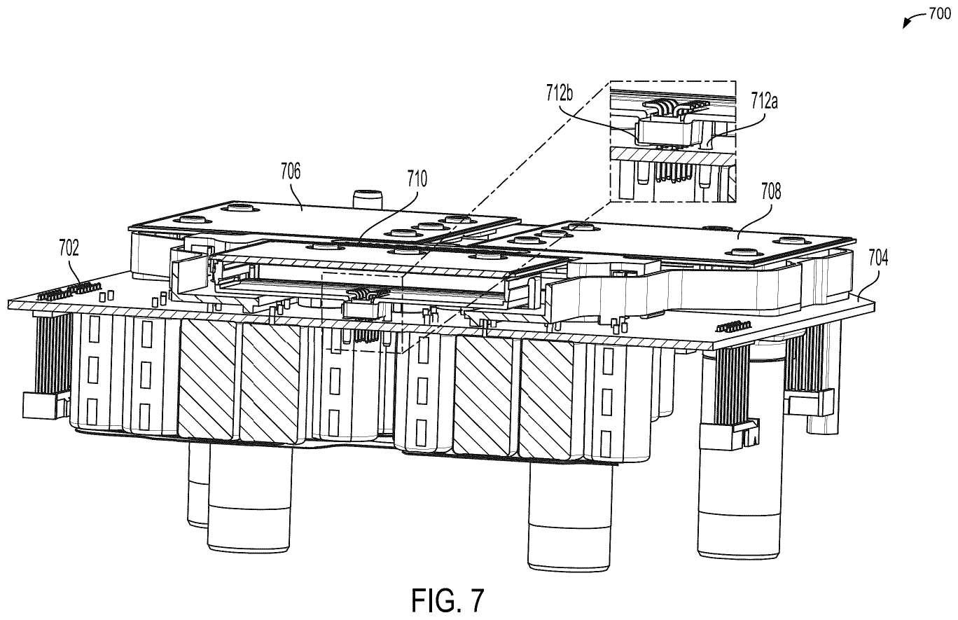

FIG. 1 schematically shows a vehicle wherein an inverter based on an inverter assembly with a holder is integrated. FIG. 2 schematically depicts an exploded view of the inverter. FIG. 3 depicts an example holder that is integrated within the inverter assembly of FIG. 2. FIG. 4 schematically shows a cross section view of the inverter assembly. FIG. 5 schematically shows an example method for assembling the inverter assembly. FIGS. 6A, 6B, 6C, 6D, and 6E schematically show different steps of assembling the inverter assembly of FIG. 2. FIG. 7 schematically shows a first perspective view of an assembled inverter assembly.

FIG. 1 shows a vehicle 100. The vehicle 100 may be a light, medium, or heavy duty vehicle. The vehicle 100 includes an electric drive unit 102. As such, the vehicle 100 may be an electric vehicle (e.g., an all-electric vehicle or a hybrid electric vehicle which includes an internal combustion engine) or a traditional internal combustion engine (ICE) vehicle. To elaborate, the electric drive unit 102 may provide motive power to one or more drive axles 140. For instance, in one use-case example, the electric drive unit 102 may include two electric axles with separate traction motors. Alternatively, the electric drive unit 102 may include one traction motor that distributes motive power to one or both of the drive axles based on vehicle operating conditions and/or operator predilection. In either example, the electric drive unit 102 may be a four-wheel electric drive unit (e.g., all-wheel electric drive unit) where front and rear drive wheels may receive motive power during certain operating conditions. In the hybrid vehicle embodiment, the vehicle 100 may include an axle receiving motive power from an electric motor and another axle that receives motive power from an internal combustion engine, during drive operation. Further, in other examples, the electric drive unit may be incorporated into a front wheel drive powertrain or a rear wheel drive powertrain.

The electric drive unit 102 includes a prime mover 104 (e.g., an electric motor, an internal combustion engine, and the like) mechanically coupled to a transmission 106. In the EV example, the electric motor may be a permanent magnet (PM) type motor that may be more generally an alternating current (AC) motor. In such an example, prime mover 104 receives electric power from an inverter 110 that in turn receives electric energy from one or more energy storage device(s) 112 (e.g., traction batteries, capacitors, combinations thereof, and the like). The inverter 110 may be integrated with the inverter assembly and a holder described in FIGS. 2 and 3. Arrows 150 denote the mechanical power transfer between the prime mover 104 and the transmission 106. Arrows 152 denote the electric power transfer between the prime mover 104 and the inverter 110, and arrows 154 denote the electric power transfer between the inverter 110 and the energy storage device(s) 112. Mechanical power may be transferred from the transmission 106 to the one or more drive axles 140 via a differential 114.

The vehicle 100 further includes a control system 170 with controller 172 (e.g., an electronic control unit (ECU) such as a transmission control unit (TCU), a vehicle control unit (VCU), combinations thereof, and the like). The controller 172 may be designed to implement control strategies. To accomplish the aforementioned vehicle control functionality, the vehicle controller may include memory 174 which stores instructions executable by a processor 176 to carry out the vehicle control strategies.

One or more input devices 178 such as a drive mode selector, accelerator pedal, brake pedal, touch interface, combinations thereof, and the like may be in electronic communication with the controller 172 as denoted by arrows 180. The drive mode selector may be a button, switch, touch interface, slider, or combinations thereof that allows the vehicle operator to trigger disconnection of the transmission 106 from the drive wheels. For instance, the drive mode selector may allow the vehicle to switch from a two-wheel drive mode to a four-wheel drive mode, when the vehicle includes a second electric axle. The controller 172 may control one or more components of vehicle 100 via one or more actuators 179. For example, an actuator of the one or more actuators 179 may control the disconnection of the transmission 106 from the drive wheels.

An axis system 199 is provided in FIG. 1 for reference. The z-axis may be a vertical axis (e.g., parallel to a gravitational axis), the x-axis may be a lateral axis (e.g., horizontal axis), and/or the y-axis may be a longitudinal axis, in one example.). However, the axes may have other orientations, in other examples.

FIG. 2 depicts an inverter assembly 200 with a holder 212 that positions, centers, and insulates various components of the inverter assembly. The inverter assembly 200 further includes a baseplate 202, a plurality of power modules, a removable locking member 206 of the holder 212, a plurality of power terminals 208, a pair of busbars 210, a plurality of supporting members 214, a power board 216, a plurality of standoffs 218, and a plurality of fasteners 220. The baseplate 202 may operate as a heatsink that transports heat generated by the electrical components (e.g., the busbars, the power terminals, power board, etc.) to an exterior of the inverter assembly 200 to reduce damage to the inverter assembly.

The holder 212 ensures proper placement of the various components of the inverter assembly 200. In particular, the holder 212 positions the plurality of power modules, including a first power module 204a, a second power module 204b, and a third power module 204c, the pair of busbars 210, and the plurality of power terminals 208. In this way, proper contact between the plurality of power modules, the pair of busbars 210, and the plurality of power terminals 208 and the baseplate 202 may be achieved. The holder 212 also enables a sub-assembled block to be constructed. The sub-assembled block facilitates subsequent assembly steps of the inverter assembly. Further, the configuration of the holder 212 prevents the power board 216 from bending when the power board is coupled with the pair of busbars 210, the plurality of power terminals, and the plurality of power modules. Further, the holder 212 is able to compensate for tolerances in planarity and flatness of the power board 216.

In particular, the integration of clips and blocking fasteners into the holder enable the power board 216, the pair of busbars 210, and the plurality of power modules to be positioned and centered without the use of screws and other fasteners. As such, ease of handling the sub-assembled power stage of the inverter assembly 200 may increase due to relying on the sub-assembled block instead of individual parts. In turn, the increase in ease of handling may reduce the takt time due to the assembly of the power stage sub-assembly being able to be performed in parallel with the inverter assembly line. Additionally, the holder 212 is configured such that the components of the inverter assembly 200 may not assemble improperly due to a poka-yoke design.

Additionally, the holder 212 may be fabricated from a plastic material with a pre-determined comparative tracking index (CTI) and may adequately provide electrical insulation of high voltage or high current components of the inverter assembly 200. In particular, the holder 212 is configured for electrical insulation of the power board 216, the pair of busbars 210, and the plurality of power modules. Further, the holder 212 is configured for electrical insulation between each high voltage and high current component of the inverter assembly 200 and the baseplate 202. The electrical insulation is achieved with insulating fasteners (e.g., insulating screws) that couple the high voltage and high current components to the baseplate 202. Additionally, due to the plastic material having an adequate CTI that is interposed between high voltage/high current components and the baseplate 202, isolation distances, such as creepage and clearance, are reduced. In turn, reduced isolation distance may result in size reduction of the inverter assembly 200. The removable locking member of the holder 212 is fabricated from the same plastic material as the remainder of the holder and fabricated using the same mold.

The pair of busbars 210 may transmit electrical power received from a power source, such as a battery of a vehicle, to other components of the inverter assembly 200, such as the power board 216. The power board 216 may include a plurality of DC link capacitors and the pair of busbars 210 may be DC Link busbars. The power board 216 may transmit electrical signals to the plurality of power modules, such as the first power module 204a, the second power module 204b, and the third power module via the plurality of power terminals 208. In this way, the power board 216 may transmit electrical signals to the first power module 204a via a first power terminal. Further, the power board 216 may transmit electrical signals to the second power module 204b via a second power terminal. The power board 216 may transmit electrical signals to the third power module 204c via a third power terminal. The plurality of power modules may convert a direct current (DC) to an alternating current (AC), which may be transmitted to windings of a motor of a vehicle, for example.

The plurality of supporting members 214 may be coupled to the plurality of power terminals 208 and the pair of busbars 210 to facilitate positioning of the plurality of power terminals and the pair of busbars. In particular, one supporting member may position one of a power terminal and a busbar. The plurality of supporting members 214, the plurality of standoffs 218, and the plurality of fasteners extend through the holder 212 and the power board 216 to couple the plurality of power terminals 208, the plurality of power modules, and the pair of busbars to the baseplate 202.

FIG. 3 illustrates a holder 300 that positions, centers, and insulates various components of a power module device. The holder 300 may be an embodiment of the holder 212 of FIG. 2. The holder 300 is arranged with a first section 312, a second section 314, a third section 316, and a fourth section 318 to position and center a plurality of power terminals, two busbars, a plurality of power modules, and a plurality of insulators that position a plurality of fasteners. In particular, the plurality of power terminals, the two busbars, the plurality of power modules, and the plurality of insulators may be positioned and centered with a plurality of power board slots of the power board and a plurality of locking slots 320 disposed at various locations on the holder 300.

Each insulator may position a fastener that couples the plurality of power terminals and the two busbars to a heatsink or baseplate of the power module device. The plurality of locking slots may extend through the holder 300 and each locking slot may be positioned next to one locking clip of a plurality of locking clips that extends from one of a top surface or bottom surface of the holder 300. Each locking clip may couple the plurality of power terminals, the two busbars, and the plurality of power modules to the holder 300.

The first section 312 is longer and greater in width than the second section 314, the third section 316, and the fourth section 318. The second section 314 is longer and smaller in width than the third section 316. The fourth section is longer and shorter in width than both of the second section 314 and the third section 316. The shape of the first section 312 is a truncated rounded rectangle wherein the truncation occurs at each corner of the first section.

The second section 314 is contiguous with the first section 312 on one side of the second section and the shape of the second section is a truncated rounded rectangle on an opposite side of the second section. The truncation of the second section 314 is on one side of the second section, the truncated side being opposite from relative to the side contiguous with the first section 312. The third section 316 is rectangular in shape and contiguous with the second section 314. The fourth section 318 is stadium-shaped and contiguous with the third section.

The plurality of power terminal slots is configured to position and center a plurality of power terminals of the power module device. The plurality of power terminal slots is generally rectangular in shape and the holder 300 projects into each power terminal slot at both ends of the respective slot to position a pair of insulators located within the respective slot. The plurality of power terminal slots may include a first power terminal slot 310a, a second power terminal slot 310b, and a third power terminal slot 310c. In particular, two power terminal slots are positioned in the first section 312. One power terminal slot is positioned at one end of the first section 312 and another power terminal slot is positioned at another end of the first section. A plurality of insulators may be disposed in the plurality of power terminal slots, including a first insulator 306a, a second insulator 306b, a sixth insulator 306f, a seventh insulator 306g, a fourteenth insulator 306n, and a fifteenth insulator 306o.

For example, the first power terminal slot 310a and the second power terminal slot 310b may be positioned in the first section 312. The first power terminal slot 310a may be positioned at one end of the first section 312 and the second power terminal slot 310b may be positioned at the other end of the first section. Further, another power terminal slot extends from the fourth section 318 into a portion of the third section 316. As an example, the third power terminal slot 310c may extend from the fourth section 318 into a portion of the third section. As such, the third power terminal slot 310c is located within both of the third section 316 and the fourth section 318.

The holder projects into each of the first power terminal slot 310a, the second power terminal slot 310b, and the third power terminal slot 310c at both ends of the respective slot. In this way, a pair of insulators may be disposed within each of the first power terminal slot 310a, the second power terminal slot 310b, and the third power terminal slot 310c. In particular, the first insulator 306a and the second insulator 306b may be disposed within the third power terminal slot 310c, the sixth insulator 306f and the seventh insulator 306g may be disposed within the first power terminal slot 310a, and the fourteenth insulator 306n and the fifteenth insulator 306o may be disposed within the second power terminal slot 310b. In this way, each insulator may position a fastener that couples the plurality of power terminals to a heatsink (e.g., baseplate) of the power module device.

Additionally, a plurality of locking clips is integrated into the sides of the power terminal slots, a periphery of the holder 300 at one end of the holder, and the surface of the holder 300. The plurality of locking clips may include a first locking clip 302a, a second locking clip 302b, a third locking clip 302c, a fourth locking clip 302d, a fifth locking clip 302e, a sixth locking clip 302f, and a seventh locking clip 302g. The first locking clip 302a may be integrated into a side of the first power terminal slot 310a located near an edge of first section 312 of the holder 300. The second locking clip 302b may be integrated into a side of the second power terminal slot 310b located near an edge of the first section 312 of the holder 300. The first locking clip 302a is located at an opposite end of the first section 312 of the holder 300 relative to the second locking clip 302b. The third locking clip 302c may be integrated into a side of the third power terminal slot 310c, the side being included in the fourth section 318 of the holder 300.

The fourth locking clip 302d and the fifth locking clip 302e may extend from the surface of the holder 300 and may be positioned on the periphery of the holder at one end of the holder that is located in the fourth section 318. The fourth locking clip 302d is spaced apart from the fifth locking clip 302e. In contrast, the sixth locking clip 302f and the seventh locking clip 302g may extend from the surface of the holder 300 and may be positioned on the periphery of the holder at another end of the holder that is located in the first section 312. The sixth locking clip 302f may be spaced apart from the seventh locking clip 302g. The fourth locking clip 302d may be generally aligned with the sixth locking clip 302f and the fifth locking clip 302e may be generally aligned with the seventh locking clip 302g.

The plurality of power module slots is configured to position and center a plurality of power modules of the power module device. The plurality of power module slots is generally rounded rectangular in shape and each power module slot is larger in size in regards to length and width compared to the plurality of power terminal slots. The plurality of power modules slots may include a first power module slot 304a, a second power module slot 304b, and a third power module slot 304c. Two power module slots are located in a center region of the first section 312 and spaced apart from each other. One power module slot is spaced apart and aligned with one power terminal slot that is located at one end of the first section 312 and another power module slot is spaced apart and aligned with a different power terminal slot that is located at the other end of the first section.

As an example, the first power module slot 304a and the second power module slot 304b are located in the center region of the first section 312 and are spaced apart from each other. The first power module slot 304a is spaced apart and aligned with the first power terminal slot 310a that is located at one end of the first section. The second power module slot 304b is spaced apart from and aligned with the second power terminal slot 310b that is located at the other end of the first section 312. In this way, the first power module slot 304a is spaced apart from the first power terminal slot on one side of the first section 312 and is spaced apart from the second power module slot 304b on another side of the first section. In addition, the second power module slot 304b is spaced apart from the second power terminal slot 310b on another side of the second power module slot.

Further, another power module slot extends from a portion of the third section 316 to the second section 314 and is aligned with one power terminal slot located in the fourth section 318. More specifically, a third power module slot 304c may extend from a portion of the third section 316 to the second section 314 and the third power module slot 304c may be aligned with the third power terminal slot 310c. Accordingly, the third power module slot 304c is positioned within the second section 314 and the third section 316 of the holder.

The holder projects into each power module slot (e.g., the first power module slot 304a, the second power module slot 304b, and the third power module slot 304c) on one side of the respective power module slot to position three insulators within the respective power module slot. The side wherein the holder extends into the respective power module slot is closest to a center region of the holder. In this way, three insulators may be disposed within each of the first power module slot 304a, the second power module slot 304b, and the third power module slot 304c.

As an example, a third insulator 306c, a fourth insulator 306d, and a fifth insulator 306e may be disposed on a side of the third power module slot 304c closest to a center of the holder 300. Similarly, an eighth insulator 306h, a ninth insulator 306i, and a tenth insulator 306j may be disposed on a side of the first power module slot 304a that is closest to the second power module slot 304b. An eleventh insulator 306k, a twelfth insulator 306l, and a thirteenth insulator 306m may be disposed on a side of the second power module slot 304b that is closest to the first power module slot 304a.

The two busbar slots are configured to position and center a positive busbar and a negative busbar. The two busbar slots are generally circular in shape and positioned near each end of the second section 314 of the holder such that one power terminal slot is spaced between the two busbar slots. For example, the two busbar slots may include a positive busbar slot 308a and a negative busbar slot 308b. The positive busbar slot 308a may be positioned on one side of the third power module slot 304c and the negative busbar slot may be positioned on another side of the third power module slot in the second section 314 of the holder 300.

The holder 300 includes a removable locking member 301 located on an edge of the holder prior to being removed and may be used to lock the components the power module device together. For example, the removable locking member 301 may couple the plurality of power terminals, the two busbars, and the plurality of power modules together. The removable locking member 301 may be coupled to the sixth locking clip 302f and the seventh locking clip 302g. The removable locking member 301 may be removed manually by applying pressure to separate the removable locking member 301 from the holder 300.

The removable locking member 301 includes a rectangular portion 301a, a first end portion 301b, and a second end portion 301c. The first end portion 301b is located at one end and the second end portion 301c is located at another end of the removable locking member 301. Each of the first end portion 301b and the second end portion 301c extend outward from an end of the rectangular portion 301a on one side of the rectangular portion and extend outward from the respective side.

The first end portion 301b and the second end portion 301c include a first region 303a, a second region 303b, a third region 303c, and a fourth region 303d. The first region 303a is generally rectangular in shape near and positioned near the ends of the rectangular portion. The first end portion 301b and the second end portion 301c include a tiered portion that extends from the first region and comprises the second region 303b and the third region 303c. The second region 303b and the third region 303c are generally a quadrant shape. The second region 303b is positioned above third region 303c. The fourth region 303d includes a first surface that extends vertically from the first region 303a and a second surface that inclines away from the first surface. The fourth region 303d couples the removable locking member 301 to the holder 300 during assembly of power module device.

The holder 300 may also include a plurality of projecting members that extend through one surface of the holder to another surface of the holder. The plurality of projecting members may include a first projecting member 322a, a second projecting member 322b, a third projecting member 322c, and a fourth projecting member 322d. The first projecting member 322a may be positioned at one end and the second projecting member 322b may be positioned at the other end of the fourth section 318. The third projecting member 322c and the fourth projecting member 322d may be positioned on the periphery of the first section 312 of the holder. The third projecting member 322c may be positioned next to the sixth locking clip 302f and the fourth projecting member 322d may be positioned next to the seventh locking clip 302g.

FIG. 4 depicts a cross section view 400 of an inverter assembly. The inverter assembly may be an embodiment of the inverter assembly 200 of FIG. 2. The cross section view 400 depicts an assembled inverter assembly wherein a holder 406 positions, centers, and insulates a plurality of power terminals, a plurality of power modules, a positive busbar, and a negative busbar. In an assembled state of the inverter assembly, the plurality of power terminals, the positive busbar, and the negative busbar are positioned within the holder by means of a plurality of supporting members 410.

Additionally, in the assembled state of the inverter assembly, a plurality of fasteners is positioned within the plurality of insulators of the holder and through holes of a power board 404 to couple the power board 404, the plurality of power terminals, the plurality of power modules, the positive busbar, and the negative busbar to the baseplate 402. The plurality of insulators may include a first insulator 412a, a second insulator 412b, and a third insulator 412c and the plurality of fasteners may include a first fastener 414a, a second fastener 414b, and a third fastener 414c. A plurality of standoffs 408 are positioned within the power board 404.

For example, the first fastener 414a may positioned within the first insulator 412a, the second fastener 414b may be positioned within the second insulator 412b, and the third fastener 414c may be positioned within the third insulator 412c. In this way, the plurality of fasteners, such as the first fastener 414a, the second fastener 414b, and the third fastener 414c, may be electrically insulated from the plurality of power terminals, the plurality of power modules, the positive busbar, and the negative busbar when coupled to the baseplate 402.

FIG. 5 illustrates a method 500 for assembling an inverter assembly. The inverter assembly may be an embodiment of the inverter assemblies depicted in FIGS. 2 and 4. At 502, the method 500 includes positioning power terminals into a plurality of power board slots of a power board. The power terminals may be positioned into the plurality of power board slots of the power board by arranging supporting members to align with the plurality of power board slots of the power board and extending the supporting members through the power board. The supporting members may be coupled with the power terminals. In particular, each power terminal may be coupled to an end of one supporting member. The end wherein the respective power terminal is not coupled to may be extended through the plurality of power board slots until the power terminals are positioned within the plurality of power board slots of the power board. In this way, a first assembly step of the inverter assembly is achieved. An example of the first assembly step of the inverter assembly is depicted in FIG. 6A.

Turning to FIG. 6A, a first assembly step 600 is depicted wherein a plurality of power terminals are positioned into a plurality of power board slots of a power board 602. The power board 602 is configured with the plurality of power board slots, including a first power board slot that positions the first power terminal 604a, a second power board slot that positions the second power terminal 604b, and a third power board slot that positions the third power terminal 604c. The power board 602 may further include a fourth power board slot 612d that positions a positive busbar and a fifth power board 612e that positions a negative busbar.

The power board 602 may further be configured with a plurality of through holes 610 that position a plurality of standoffs or a plurality of fasteners to couple the various components of the inverter assembly to the power board. The plurality of standoffs may include a first standoff 608a located near a center of the power board 602, a second standoff 608b located in a first corner of the power board, a third standoff 608c located in a second corner of the power board, a fourth standoff 608d located in a third corner of the power board, and a fifth standoff 608e located in a fourth corner of the power board.

Each power terminal of the plurality of power terminals is coupled to one supporting member of the plurality of supporting members. The plurality of power terminals may include a first power terminal 604a, a second power terminal 604b, and a third power terminal 604c, and the plurality of supporting members may include a first supporting member (not shown), a second supporting member 606b, and a third supporting member 606c. The first power terminal 604a may be coupled to the first supporting member at one end of the first supporting member. The second power terminal 604b may be coupled to the second supporting member 606b at one end of the second supporting member. The third power terminal 604c may be coupled to the third supporting member 606c at one end of the third supporting member.

To achieve the first inverter assembly step, a first supporting member (not shown) may be extended through the first power board slot until the first power terminal 604a is positioned in the first power board slot. Additionally, the second supporting member 606b may be extended through the second power board slot until the second power terminal 604b is positioned in the second power board slot. Further, the third supporting member 606c may be extended through the third power board slot until the third power terminal 604c is positioned in the third power board slot.

Returning to FIG. 5, at 504, the method 500 includes positioning a holder with a removable locking member on top of the power board to arrange the power terminals within a plurality of power terminal slots of the holder. More specifically, the power terminals are arranged to align with insulators positioned in the plurality of power terminal slots of the holder such that one end of the power terminal surrounds one insulator and another end of the power terminal surrounds another insulator positioned in the plurality of power terminal slots. An example of a second assembly step is depicted in FIG. 6B.

Turning to FIG. 6B, a second assembly step 601 is illustrated wherein a holder 614 with a removable locking member 616 is positioned on a surface of the power board 602. The holder 614 may be an embodiment of the holder 300 of FIG. 3. FIG. 3 illustrates one surface of a holder that may be integrated within an inverter assembly. The corresponding surface of the holder 614 is positioned such that the corresponding surface is in contact with a surface of the power board 602. In this way, a first subset of a plurality of locking clips that are positioned on a periphery of the holder 614 may couple the power board 602 and the holder. The subset of locking clips may include a first locking clip 620.

The holder 614 is positioned on the surface of the power board 602 such that the plurality of power terminal slots is aligned with the plurality of power terminals to position the plurality of power terminals in a plurality of power terminal slots. In this way, the first power terminal 604a is positioned within a first power terminal slot of the holder, the second power terminal 604b is positioned within a second power terminal slot of the holder, and the third power terminal 604c is positioned within a third power terminal slot of the holder. Additionally, each of the first power terminal 604a, the second power terminal 604b, and the third power terminal 604c are positioned such that the first power terminal, the second power terminal, and the third power terminal surround two insulators disposed in each of the first power terminal slot, the second power terminal slot, and the third power terminal slot.

More specifically, one end of the first power terminal 604a surrounds a first insulator 618a and another end of the first power terminal surrounds a second insulator 618b. It follows that one end of the second power terminal 604b surrounds a third insulator 618c and another end of the second power terminal surrounds a fourth insulator 618d. Further, one end of the third power terminal 604c surrounds a fifth insulator 618e and another end of the third power terminal surrounds a sixth insulator 618f. Each of the first insulator 618a, the second insulator 618b, the third insulator 618c, the fourth insulator 618d, the fifth insulator 618e, and the sixth insulator 618f may be one insulator of a plurality of insulators of the holder 614.

Returning to FIG. 5, at 506, the method 500 includes positioning the two busbars into two busbar slots of the holder. The two busbars may be positioned within the two busbar slots by aligning through holes of each respective busbar with insulators of the holder and extending supporting members coupled to the busbars through the power board and holder until the two busbars are positioned within the two busbar slots. As described herein, one of the two busbars may be a positive busbar and the other busbar may be a negative busbar, and thus, one of the busbar slots may be a positive busbar slot and the other busbar slot may be a negative busbar slot.

Accordingly, the positive busbar may be positioned in the positive busbar slot by aligning through holes of the positive busbar with insulators of the holder and extending a supporting member coupled to the positive busbar through the power board and holder until the positive busbar is positioned within the positive busbar slot. The negative busbar may be positioned in the negative busbar slot by aligning through holes of the negative busbar with insulators of the holder and extending a supporting member coupled to the negative busbar through the power board and holder until the negative busbar is positioned within the negative busbar slot. A third inverter assembly step may be achieved by aligning the through holes of the positive busbar and the negative busbar with insulators disposed within a plurality of power module slots, respectively, and partially extending the supporting members coupled to the positive busbar and the negative busbar through the positive busbar slot and negative busbar slot, respectively. An example of the third inverter assembly step is illustrated in FIG. 6C.

Turning to FIG. 6C, a third inverter assembly step 603 wherein the through holes of the two busbars are aligned with insulators of the holder 614 and the supporting members coupled to the two busbars are partially extended through the busbar slots. More specifically, a fourth supporting member 606d of the plurality of supporting members may be coupled to a negative busbar 624 and a fifth supporting member 606e may be coupled to a positive busbar 622. The fifth supporting member 606e may be partially extended through the positive busbar slot of the holder 614 prior to the fourth supporting member 606d being partially extended through the negative busbar slot.

The fifth supporting member 606e may be partially extended through the positive busbar slot such that the plurality of through holes of the positive busbar are aligned with a plurality of insulators disposed within the plurality of power module slots of the holder 614. To be more specific, the plurality of insulators may be disposed within a first power module slot, a second power module slot, and a third power module slot of the holder 614. The positive busbar slot may include a first through hole 622a, a second through hole 622b, a third through hole 622c, a fourth through hole 622d, a fifth through hole 622e, and a sixth through hole (not shown). The plurality of insulators may include a seventh insulator 618g, a ninth insulator 618i, a tenth insulator 618j, a twelfth insulator 618l, a thirteenth insulator 618m, and a fifteenth insulator (not shown).

The first through hole 622a may be aligned with a seventh insulator 618g disposed within a third power module slot, the second through hole 622b may be aligned with the ninth insulator 618i disposed within the third power module slot, and the third through hole 622c may be aligned with the tenth insulator 618j disposed within a second power module slot of the holder 614. Further, the fourth through hole 622d may be aligned with the twelfth insulator 618l disposed within the second power module slot, the fifth through hole 622e may be aligned with the thirteenth insulator 618m disposed within a first power module slot, and the sixth through hole (not shown) may be aligned with the fifteenth insulator (not shown) disposed within the first power module slot.

The fourth supporting member 606d may be partially extended through the negative busbar slot such that the plurality of through holes of the negative busbar are aligned with a plurality of insulators disposed within the plurality of power modules slots of the holder (e.g., the first power module slot, the second power module slot, and the third power module slot). The negative busbar 624 may include a first through hole 624a, a second through hole 624b, and a third through hole 624c.

The plurality of insulators may include an eighth insulator 618h, an eleventh insulator 618k, and a fourteenth insulator (not shown). The first through hole 624a may be aligned with the eighth insulator 618h disposed within the third power module slot, the second through hole 624b may be aligned with the eleventh insulator 618k disposed within the second power module slot, and the third through hole 622c may be aligned with the fourteenth insulator (not shown) disposed within the first power module slot.

FIG. 6D depicts a fourth assembly step 605 wherein the fifth supporting member 606e and the fourth supporting member 606d are fully extended through the power board 602 and holder 614 to position the positive busbar 622 and the negative busbar 624 within the positive busbar slot and the negative busbar slot, respectively. Fully extending the fifth supporting member 606e coupled to the positive busbar 622 through the positive busbar slot enables the positive busbar to surround the seventh insulator 618g disposed within the third power module slot, the ninth insulator 618i disposed within the third power module slot, the tenth insulator 618j disposed within the second power module slot, the twelfth insulator 618l disposed within the second power module slot, the thirteenth insulator 618m disposed within the first power module slot, and a fifteenth insulator 618o disposed within the first power module slot of the holder 614.

In particular, the positive busbar 622 surrounds the seventh insulator 618g in response to the seventh insulator being extended through the first through hole 622a, surrounds the ninth insulator 618i in response to the ninth insulator being extended through the second through hole 622b, and surrounds the tenth insulator 618j in response to the tenth insulator being extended through the third through hole 622c. Further, the positive busbar 622 surrounds the twelfth insulator 618l in response to the twelfth insulator being extended through the fourth through hole 622c, surrounds the thirteenth insulator 618m in response to the thirteenth insulator being extended through the fifth through hole 622e, and surrounds a fifteenth insulator 618o in response to the fifteenth insulator being extended through a sixth through hole 622f.

Similarly, fully extending the fourth supporting member 606d coupled to the negative busbar 624 through the negative busbar slot enables the negative busbar to surround the eighth insulator 618h disposed within the third power module slot, the eleventh insulator 618k disposed within the second power module slot, and a fourteenth insulator 618n disposed within the first power module slot. More specifically, the negative busbar 624 surrounds the eighth insulator 618h in response to the eighth insulator being extended through the first through hole 624a, surrounds the eleventh insulator 618k in response to the eleventh insulator being extended through the second through hole 624b, and surrounds the fourteenth insulator 618n in response to the fourteenth insulator being extended through the third through hole 624c.

In this way, a first overlapping portion 623a of the positive busbar 622 and the negative busbar 624 are positioned between the first power module slot and the second power module on one side and the third power module slot on another side of the positive busbar and the negative busbar. Further, a second overlapping portion 623b of the positive busbar 622 and the negative busbar 624 are positioned between the first power module slot and the second power module slot. As such, the first power module slot is positioned on one side of the positive busbar 622 and the negative busbar 624 and the second power module slot is positioned on another side of the positive busbar 622 and the negative busbar 624.

Returning to FIG. 5, at 508, the method 500 includes removing the removable locking member from the holder and positioning the removable locking member in a center region of the holder. The removable locking member may be removed manually by applying pressure to separate the removable locking member 301 from the holder. After separating the removable locking member from the side of the holder, the removable locking member may be positioned above the assembled positive busbar and the negative busbar in a center region of the holder. More specifically, the removable locking element may be positioned above a first overlapping portion of the positive busbar and the negative busbar.

The removable locking member may be positioned accordingly by coupling the end portions of the removable locking member with a pair of locking slots. One locking slot being located on one side of the holder and another locking slot being located on an opposite side of the holder. In this way, the removable locking member may be coupled to the holder by means of locking clips positioned on an opposite surface of the holder.

Returning to FIG. 6D, the fourth assembly step 605 of the inverter assembly includes the removable locking member 616 being positioned on top of the positive busbar 622 and the negative busbar 624 in a center region of the holder 614. The removable locking member 616 may be positioned on the first overlapping portion 623a of the positive busbar 622 and the negative busbar 624. One end of the removable locking member 616 is coupled to the holder 614 on one side of the holder and another end of the removable locking member is coupled to the holder on another side of the holder.

Returning to FIG. 5, at 510, the method 500 includes positioning power modules in a plurality of power modules slots of the holder. As described herein, the plurality of power module slots includes a first power module slot, a second power module slot, and a third power module slot. Positioning power modules in a plurality of power module slots may include aligning insulators of the holder with through holes positioned on a surface of the power modules and extending the insulators through the through holes until the power modules are touching the holder and the power board. A first power module may be positioned by aligning insulators disposed in the first power module slot with through holes positioned on a surface of the first power module and extending the insulators disposed in the first power module slot until the first power module, the power board, and the holder are touching.

A second power module may be positioned by aligning insulators disposed in the second power module slot with through holes positioned on a surface of the second power module and extending the insulators disposed in the second power module slot until the second power module, the power board, and the holder are touching. A third power module may be positioned by aligning insulators disposed in the third power module slot with through holes positioned on a surface of the third power module and extending the insulators disposed in the third power module slot until the third power module, the power board, and the holder are touching. In this way, a first power module may be positioned in a first power module slot of the holder, a second power module may be positioned in a second power module slot of the holder, and a third power module may be positioned in a third power module slot of the holder, which is illustrated in FIG. 6E. Further, the first power module 626, the second power module 628, and the third power module 630 may be coupled to the holder via a plurality of locking clips.

Turning to FIG. 6E, a fifth inverter assembly step 607 wherein each power module is positioned within a respective power module slot is illustrated. The fifth inverter assembly step 607 includes a first power module 626 being positioned within a first power module slot, a second power module 628 being positioned within a second power module slot, and a third power module 630 being positioned within a third power module slot. A surface of the first power module 626 includes a first through hole 626a, a second through hole 626b, a third through hole 626c, a fourth through hole 626d, and a fifth through hole 626e.

The first power module 626 is positioned such that first through hole 626a may be aligned with and surrounds the first insulator 618a and the second through hole 626b may be aligned with and surrounds the second insulator 618b. Further, the first power module 626 is positioned such that the third through hole 626c may be aligned with and surrounds the fifteenth insulator 618o, the fourth through hole 626d may be aligned with and surrounds the fourteenth insulator 618n, and the fifth through hole 626e may be aligned with and surrounds the thirteenth insulator 618m.

A surface of the second power module 628 includes a first through hole 628a, a second through hole 628b, a third through hole 628c, a fourth through hole 628d, and a fifth through hole 628e. The second power module 628 is positioned such that first through hole 628a may be aligned with and surrounds the third insulator 618c and the second through hole 628b may be aligned with and surrounds the fourth insulator 618d. Further, the second power module 628 is positioned such that the third through hole 628c may be aligned with and surrounds the tenth insulator 618j, the fourth through hole 628d may be aligned with and surrounds the eleventh insulator 618k, and the fifth through hole 628e may be aligned with and surrounds the twelfth insulator 618l.

A surface of the third power module 630 includes a first through hole 630a, a second through hole 630b, a third through hole 630c, a fourth through hole 630d, and a fifth through hole 630e. The third power module 630 is positioned such that first through hole 630a may be aligned with and surrounds the fifth insulator 618e and the second through hole 630b may be aligned with and surrounds the sixth insulator 618f. Further, the third power module 630 is positioned such that the third through hole 630c may be aligned with and surrounds the seventh insulator 618g, the fourth through hole 630d may be aligned with and surrounds the eighth insulator 618h, and the fifth through hole 630e may be aligned with and surrounds the ninth insulator 618i.

Each of the first power module 626, the second power module 628, and the third power module 630 may be coupled to the holder 614 via a plurality of locking clips. For example, the plurality of locking clips may include a second locking clip 632. The second locking clip 632 may couple the third power module 630 to the holder 614. At 512, the method 500 includes extending a plurality of fasteners through through holes on a surface of the power board to position the plurality of fasteners within insulators to couple the power terminals, the two busbars, and the power modules to the power board. More specifically, the plurality of fasteners may be positioned within the plurality of insulators to couple the first power terminal, the second power terminal, the third power terminal, the positive busbar, the negative busbar, the first power module, the second power module, and the third power module to the power board. Further, the plurality of fasteners may couple the first power module, the second power module, and the third power module to the baseplate. The method 500 then ends.

FIG. 7 depicts a perspective view 700 of an assembled power inverter assembly. The assembled power inverter assembly may be performed according to the method described in FIG. 7. The assembled power inverter assembly includes a power board 702 coupled to a first power module 706, a second power module 708, a third power module 710, a positive busbar, a negative busbar, a first power terminal, a second power terminal, and a third terminal. Each of the first power module 706, the second power module 708, the third power module 710, the positive busbar, the negative busbar, the first power terminal, the second power terminal, and the third power terminal are positioned, centered, and insulated with the holder 704 according to embodiments described herein.

Each power module integrates two centering pins near a signal connector to facilitate placement of the signal connector into the power board 702. The power board is configured with two through holes to position the two centering pins. For example, a first centering pin 712a may extend through one through hole of the power board 702 and a second centering pin 712b may extend through another through hole of the power board. The first centering pin 712a and the second centering pin 712b may facilitate placement of the signal connector into the power board 702.

The technical effect of integrating a holder with a removable locking member is that a number of components of a power module device and thus, a number of assembly steps may be reduced due to the holder being configured with various locking and insulating features that enable the holder to position, center, and insulate various components of the power module device. In turn, the holder may result in less assembly errors and reduced take times during assembly of the power module device, such as an inverter assembly.

The disclosure also provides support for a holder for a power module device, comprising: a plurality of power terminal slots configured for positioning and centering power terminals, two busbar slots configured for positioning and centering two busbars, a plurality of power module slots configured for positioning and centering power modules, a plurality of locking slots for coupling the plurality of power terminals, two busbars, and a plurality of power boards to the holder, a plurality of insulators disposed in the plurality of power terminal slots and the plurality of power module slots wherein each insulator positions a fastener that couples the plurality of power terminals and the two busbars to a heatsink of the power module device, a plurality of locking clips integrated into sides of the plurality of power terminal slots, a periphery of the holder at each end of the holder, and a surface of the holder, and a removable locking member located on an edge of the holder prior to being removed.

In a first example of the system, the system further comprises: a first section that is a truncated rounded rectangle in shape, a second section that is contiguous with the first section on one side and is a truncated rounded rectangle in shape wherein a truncation is on an opposite side of the second section, a third section that is rectangular in shape and contiguous with the second section, and a fourth section that is stadium-shaped and contiguous with the third section. In a second example of the system, optionally including the first example, the first section is longer and greater in width than the second section, the third section, and the fourth section, the second section is longer and smaller in width than the third section, and the fourth section is longer and shorter in width than both of the second section and the fourth section.

In a third example of the system, optionally including one or both of the first and second examples, two power terminal slots are positioned in the first section, one power terminal slot being located at one end and another power terminal slot being located at another end of the first section. In a fourth example of the system, optionally including one or more or each of the first through third examples, one power terminal slot extends from the fourth section into a portion of the third section. In a fifth example of the system, optionally including one or more or each of the first through fourth examples, the plurality of power terminal slots is generally rectangular in shape and the holder projects into each power terminal slot at both ends of the respective power terminal slot to position a pair of insulators located within the respective power terminal slot.

In a sixth example of the system, optionally including one or more or each of the first through fifth examples two power modules slots are spaced apart from each other and located in the first section such that one power module is spaced apart and aligned with one power terminal slot on one end of the first section and another power module is spaced apart and aligned with another power terminal slot on another end of the first section. In a seventh example of the system, optionally including one or more or each of the first through sixth examples, one power module slot extends from a portion of the third section to the second section and is aligned with one power terminal slot located in the fourth section and the plurality of power module slots is generally rounded rectangular in shape and larger in size than the plurality of power terminal slots.

In an eighth example of the system, optionally including one or more or each of the first through seventh examples, the holder projects into each power module slot on one side of the respective power module slot to position three insulators within the respective power module slot. In a ninth example of the system, optionally including one or more or each of the first through eighth examples, the two busbar slots are generally circular in shape and positioned near each end of the second section of the holder such that one power terminal slot is spaced between the two busbar slots. In a tenth example of the system, optionally including one or more or each of the first through ninth examples, the removable locking member is fabricated with a same mold and with a same material as the holder.

The disclosure also provides support for a method for power module device assembly, comprising, positioning power terminals into a plurality of power board slots of a power board, positioning a holder with a removable locking member on top of the power board to arrange the power terminals within a plurality of power terminal slots of the holder, positioning two busbars into two busbar slots of the holder, removing the removable locking member from the holder and positioning the removable locking member in a center region of the holder, positioning power modules in a plurality of power module slots of the holder, and extending a plurality of fasteners through through holes on a surface of the power board to position the plurality of fasteners within insulators to couple the power terminals, the two busbars, and the power modules to the power board. In a first example of the method, positioning power terminals into the plurality of power board slots of the power board comprises arranging supporting members to align with the plurality of power board slots of the power board, the supporting members being coupled with the power terminals and extending the supporting members through the power board.

In a second example of the method, optionally including the first example, positioning the two busbars into the two busbar slots of the holder comprises aligning through holes of each busbar with insulators of the holder and extending supporting members coupled to the two busbars through the power board and holder until the two busbars are positioned within the two busbar slots. In a third example of the method, optionally including one or both of the first and second examples, positioning power modules in the plurality of power module slots of the holder comprises aligning the insulators with through holes positioned on a surface of the power modules and extending the insulators through the through holes until the power modules are touching the holder and the power board.

The disclosure also provides support for an inverter assembly, comprising: a power board comprising a plurality of power board slots for positioning a first power terminal, a second power terminal, and a third power terminal, a positive busbar, and a negative busbar, a first power module, a second power module, and a third power module, a holder with a removable locking member, comprising: a first power terminal slot located at one end of a first section of the holder, a second power terminal slot located at another end of the first section of the holder, and a third power terminal slot located within both of a third section and a fourth section of the holder, a first power module slot that is spaced apart from the first power terminal slot on one side and is spaced apart from a second power module slot on another side of the first power module slot, the second power module slot being spaced apart from the second power terminal slot on another side of the second power module slot, a third power module slot that is spaced apart from the third power terminal and is located within a second section and the third section of the holder, a positive busbar slot positioned on one side of the third power module slot and a negative busbar slot positioned on another side of the third power module slot in the second section of the holder, and a plurality of insulators that position a plurality of fasteners and is disposed in each of the first power terminal slot, the second power terminal slot, the third power terminal slot, the first power module slot, the second power module slot, and the third power module slot, a plurality of locking slots and a plurality of locking clips to couple each of the first power terminal, the second power terminal, the third power terminal, the positive busbar, the negative busbar, the first power module, the second power module, and the third power module to the holder, and a baseplate that operates as a heatsink, and the plurality of fasteners that couple the baseplate to the first power module, the second power module, the third power module, the positive busbar, the negative busbar, the first power terminal, the second power terminal, the third power terminal, and the power board.

In a first example of the system, the holder is positioned on a surface of the power board. In a second example of the system, optionally including the first example, the first power terminal, the second power terminal, and the third power terminal are positioned in the first power terminal slot, the second power terminal slot, and the third power terminal slot of the holder, respectively and surround two insulators disposed in the first power terminal slot, the second power terminal slot, and the third power terminal slot. In a third example of the system, optionally including one or both of the first and second examples, the positive busbar is positioned within the positive busbar slot and the negative busbar is positioned within the negative busbar slot to enable the positive busbar and the negative busbar to surround the plurality of insulators located within the first power module slot, the second power module slot, and the third power module slot. In a fourth example of the system, optionally including one or more or each of the first through third examples, the first power module, the second power module, and the third power module are positioned in the first power module slot, the second power module slot, and the third power module slot, respectively, and are coupled to the baseplate via fasteners.

FIGS. 2, 3, 4, 6A-6E, and 7 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

The foregoing description is considered as illustrative only of the principles of the described embodiments. Further, since numerous modifications and changes will readily occur to those skilled in the art, it is not desired to limit the described embodiments to the exact construction and processes shown and described herein. Accordingly, all suitable modifications and equivalents may be considered as falling within the scope of the described embodiments as defined by the claims which follow.

1. A holder for a power module device, comprising:
a plurality of power terminal slots configured for positioning and centering power terminals;
two busbar slots configured for positioning and centering two busbars;
a plurality of power module slots configured for positioning and centering power modules;
a plurality of locking slots for coupling the plurality of power terminals, two busbars, and a plurality of power boards to the holder;
a plurality of insulators disposed in the plurality of power terminal slots and the plurality of power module slots wherein each insulator positions a fastener that couples the plurality of power terminals and the two busbars to a heatsink of the power module device;
a plurality of locking clips integrated into sides of the plurality of power terminal slots, a periphery of the holder at each end of the holder, and a surface of the holder; and
a removable locking member located on an edge of the holder prior to being removed.

2. The holder of the power module device of claim 1, further comprising:
a first section that is a truncated rounded rectangle in shape;
a second section that is contiguous with the first section on one side and is a truncated rounded rectangle in shape wherein a truncation is on an opposite side of the second section;
a third section that is rectangular in shape and contiguous with the second section; and
a fourth section that is stadium-shaped and contiguous with the third section.

3. The holder of the power module device of claim 2, wherein the first section is longer and greater in width than the second section, the third section, and the fourth section, the second section is longer and smaller in width than the third section, and the fourth section is longer and shorter in width than both of the second section and the fourth section.

4. The holder of the power module device of claim 3, wherein two power terminal slots are positioned in the first section, one power terminal slot being located at one end and another power terminal slot being located at another end of the first section.

5. The holder of the power module device of claim 4, wherein one power terminal slot extends from the fourth section into a portion of the third section.

6. The holder for the power module device of claim 5, wherein the plurality of power terminal slots are generally rectangular in shape and the holder projects into each power terminal slot at both ends of the respective power terminal slot to position a pair of insulators located within the respective power terminal slot.

7. The holder of the power module device of claim 3, two power modules slots are spaced apart from each other and located in the first section such that one power module is spaced apart and aligned with one power terminal slot on one end of the first section and another power module is spaced apart and aligned with another power terminal slot on another end of the first section.

8. The holder of the power module device of claim 7, wherein one power module slot extends from a portion of the third section to the second section and is aligned with one power terminal slot located in the fourth section and the plurality of power module slots is generally rounded rectangular in shape and larger in size than the plurality of power terminal slots.

9. The holder for the power module device of claim 8, wherein the holder projects into each power module slot on one side of the respective power module slot to position three insulators within the respective power module slot.

10. The holder for the power module device of claim 3, wherein the two busbar slots are generally circular in shape and positioned near each end of the second section of the holder such that one power terminal slot is spaced between the two busbar slots.

11. The holder for the power module device of claim 1, wherein the removable locking member is fabricated with a same mold and with a same material as the holder.

12. A method for power module device assembly, comprising;
positioning power terminals into a plurality of power board slots of a power board;
positioning a holder with a removable locking member on top of the power board to arrange the power terminals within a plurality of power terminal slots of the holder;
positioning two busbars into two busbar slots of the holder;
removing the removable locking member from the holder and positioning the removable locking member in a center region of the holder;
positioning power modules in a plurality of power module slots of the holder; and
extending a plurality of fasteners through through holes on a surface of the power board to position the plurality of fasteners within insulators to couple the power terminals, the two busbars, and the power modules to the power board.

13. The method of claim 12, wherein positioning power terminals into the plurality of power board slots of the power board comprises arranging supporting members to align with the plurality of power board slots of the power board, the supporting members being coupled with the power terminals and extending the supporting members through the power board.

14. The method of claim 12, wherein positioning the two busbars into the two busbar slots of the holder comprises aligning through holes of each busbar with insulators of the holder and extending supporting members coupled to the two busbars through the power board and holder until the two busbars are positioned within the two busbar slots.

15. The method of claim 12, wherein positioning power modules in the plurality of power module slots of the holder comprises aligning the insulators with through holes positioned on a surface of the power modules and extending the insulators through the through holes until the power modules are touching the holder and the power board.

16. An inverter assembly, comprising:
a power board comprising a plurality of power board slots for positioning a first power terminal, a second power terminal, and a third power terminal, a positive busbar, and a negative busbar;
a first power module, a second power module, and a third power module;
a holder with a removable locking member, comprising:
a first power terminal slot located at one end of a first section of the holder, a second power terminal slot located at another end of the first section of the holder, and a third power terminal slot located within both of a third section and a fourth section of the holder;
a first power module slot that is spaced apart from the first power terminal slot on one side and is spaced apart from a second power module slot on another side of the first power module slot, the second power module slot being spaced apart from the second power terminal slot on another side of the second power module slot;
a third power module slot that is spaced apart from the third power terminal and is located within a second section and the third section of the holder;
a positive busbar slot positioned on one side of the third power module slot and a negative busbar slot positioned on another side of the third power module slot in the second section of the holder; and
a plurality of insulators that position a plurality of fasteners and is disposed in each of the first power terminal slot, the second power terminal slot, the third power terminal slot, the first power module slot, the second power module slot, and the third power module slot;
a plurality of locking slots and a plurality of locking clips to couple each of the first power terminal, the second power terminal, the third power terminal, the positive busbar, the negative busbar, the first power module, the second power module, and the third power module to the holder; and
a baseplate that operates as a heatsink; and
the plurality of fasteners that couple the baseplate to the first power module, the second power module, the third power module, the positive busbar, the negative busbar, the first power terminal, the second power terminal, the third power terminal, and the power board.

17. The inverter assembly of claim 16, wherein the holder is positioned on a surface of the power board.

18. The inverter assembly of claim 16, wherein the first power terminal, the second power terminal, and the third power terminal are positioned in the first power terminal slot, the second power terminal slot, and the third power terminal slot of the holder, respectively and surround two insulators disposed in the first power terminal slot, the second power terminal slot, and the third power terminal slot.

19. The inverter assembly of claim 16, wherein the positive busbar is positioned within the positive busbar slot and the negative busbar is positioned within the negative busbar slot to enable the positive busbar and the negative busbar to surround the plurality of insulators located within the first power module slot, the second power module slot, and the third power module slot.

20. The inverter assembly of claim 16, wherein the first power module, the second power module, and the third power module are positioned in the first power module slot, the second power module slot, and the third power module slot, respectively, and are coupled to the baseplate via fasteners.
